(19) United States
(12) Patent Application Publication
(10) Pub. No.: US 2026/0249410 A1
(43) Pub. Date: Aug. 27, 2026

(54) DEVICE FOR CLAMPING WORKPIECES ON MACHINE TOOLS

(71) Applicant: Hydroblock S.r.l., Reggio Emilia, Reggio Emilia (IT)

(72) Inventor: Davide ZANNI, Reggio Emilia, Reggio Emilia (IT)

(73) Assignee: Hydroblock S.r.l., Reggio Emilia, Reggio Emilia (IT)

(21) Appl. No.: 19/131,996

(22) PCT Filed: Nov. 22, 2023
(86) PCT No.: PCT/IB2023/061771

§ 371 Date: May 22, 2025

(30) Foreign Application Priority Data
Nov. 24, 2022 (IT) 102022000024216

(51) Int. Cl. B23Q 3/10; B25B 5/08

(52) U.S. Cl. CPC B23Q 3/106; B25B 5/087

(57) ABSTRACT

The device (1) for clamping workpieces on machine tools comprises:
a base body (2);
a clamping pin (3) movable along a direction of work (L) between an extended position and a retracted position;
a blocking bushing (12) fitted around the clamping pin (3);
a supporting assembly (15, 16) adapted to physically support the clamping pin (3) in the extended position and comprising:
   a supporting element (15) defining a respective first resting surface (15a); and
   shifting means (16) adapted to move the supporting element (15) along the direction of work (L) and to arrange it, when the clamping pin (3) is in the extended position, in a supporting configuration wherein the first resting surface (15a) is placed in contact with a respective second resting surface (3a) of the clamping pin (3).

### TECHNICAL FIELD

The present invention relates to a device for clamping workpieces on machine tools.

### BACKGROUND ART

As is well known, in mass production of mechanical workpieces requiring machining at the machine tool, the use of highly automated systems is widespread wherein one or more machine tools are electronically controlled by a processing and control unit and one or more anthropomorphic robots bring the workpieces to be machined to the machine tools, where special clamping devices, either oil-hydraulic or pneumatic, take over the workpiece and clamp it in position to allow machining.

When machining is completed, the aforementioned clamping devices release the machined workpiece, which is moved away once again by the robots.

One particular type of clamping devices comprises a base body which can be fixed to the machine tool and a pin, housed at least partly within the base body itself, which is moved by oil-hydraulic drives between an extended position, wherein it allows clamping the workpiece on the machine tool, and a retracted position, wherein it allows releasing the workpiece from the machine tool.

In more detail, in order to ensure secure clamping of the workpiece when the pin is in the extended position, these devices are provided with a special elastic bushing fitted to measure on the pin and adapted to prevent the latter from returning to the retracted position.

Specifically, during the switch of the pin from the retracted position to the extended position, the elastic bushing is pressurized by sending pressurized oil and, by compressing radially on the pin, it generates a restraining force on the latter which counteracts the movement thereof by friction, clamping it in the extended position.

Once machining of the workpiece is completed, the elastic bushing can be depressurized and the restraining force generated thereby on the pin can thus be removed; in this way, the pin can be returned to the retracted position and allow, by virtue of this, the release of the workpiece.

As can be appreciated, the engineering of the clamping devices discussed so far is expressly aimed at ensuring that the movement of the pin is carried out exclusively through the aforementioned modes and, in particular, that it is in no way affected by the forces exerted by the workpiece on the pin itself.

In other words, the devices in question are specially designed to prevent the stresses discharged by the workpiece onto the pin from resulting in even a slight displacement of the latter from the extended position, so that the workpiece can be firmly and stably fixed on the machine tool.

However, this requirement, which is obviously essential to ensure proper workpiece machining, is not met by known devices in some specific operational conditions, particularly when the forces exerted by the workpiece on the pin exceed a certain upper threshold limit.

In this case, in fact, the peak load generated by the workpiece on the pin structurally deforms the elastic bushing which, by compressing axially, is no longer able to hold the latter firmly in place and, as an inevitable result, induces its slight “elastic” sinking into the base body.

This fact, in itself undesirable for any type of machining, proves to be exceedingly unacceptable in industrial contexts such as precision mechanics where, as is well known, even slight errors (e.g., of a few hundredths of a millimeter) can result in the production of workpieces which are largely out of tolerance and, therefore, to be discarded.

If, therefore, the attainment of such stresses implies the serious consequences described above, a further increase in the forces operating on the pin results no longer in a slight displacement of the latter from the extended position, but in its complete collapse into the base body and, therefore, in the total impairment of the clamping capacity of the device.

It must, in fact, be explained that the deformation undergone by the bushing in this circumstance is such that it loses its grip on the pin and consequently leads to the return of the latter to the retracted position which, by releasing its grip on the workpiece, entails obvious and inadmissible consequences on the machining quality of the same.

### DESCRIPTION OF THE INVENTION

The main aim of the present invention is to devise a device for clamping workpieces on machine tools with precise and reliable operation which enables a workpiece to be firmly clamped on a machine tool regardless of the magnitude of the forces exerted thereon.

One object of the present invention is to devise a device for clamping workpieces on machine tools which provides, its size being equal, greater performance than known devices and, at the same time, can be undersized compared to the latter for the same performance.

Another object of the present invention is to devise a device for clamping workpieces on machine tools which can hold the workpiece firmly clamped on the machine tool even in the event of a possible and unexpected pressure drop in the device itself.

Another object of the present invention is to devise a device for clamping workpieces on machine tools which can overcome the aforementioned drawbacks of the prior art within the framework of a simple, rational, easy and effective to use as well as affordable solution.

The aforementioned objects are achieved by this device for clamping workpieces on machine tools having the characteristics of claim 1.

### BRIEF DESCRIPTION OF THE DRAWINGS

Other characteristics and advantages of the present invention will become more apparent from the description of a preferred, but not exclusive, embodiment of a device for clamping workpieces, illustrated by way of an indicative, yet non-limiting example, in the attached tables of drawings wherein:

FIG. 1 is an axonometric view of the device according to the invention;

FIG. 2 is an exploded view of the device according to the invention;

FIG. 3 is a front view of the device according to the invention;

FIG. 4 is a cross-sectional view, along the IV-IV plane of FIG. 3, of the device according to the invention in a first operational configuration;

FIG. 5 is a cross-sectional view, along the V-V plane of FIG. 3, of the device according to the invention in the first operational configuration;

FIG. 6 shows the same cross-sectional view as in FIG. 4 with the device according to the invention in a second operational configuration;

FIG. 7 shows the same cross-sectional view as in FIG. 5 with the device according to the invention in the second operational configuration.

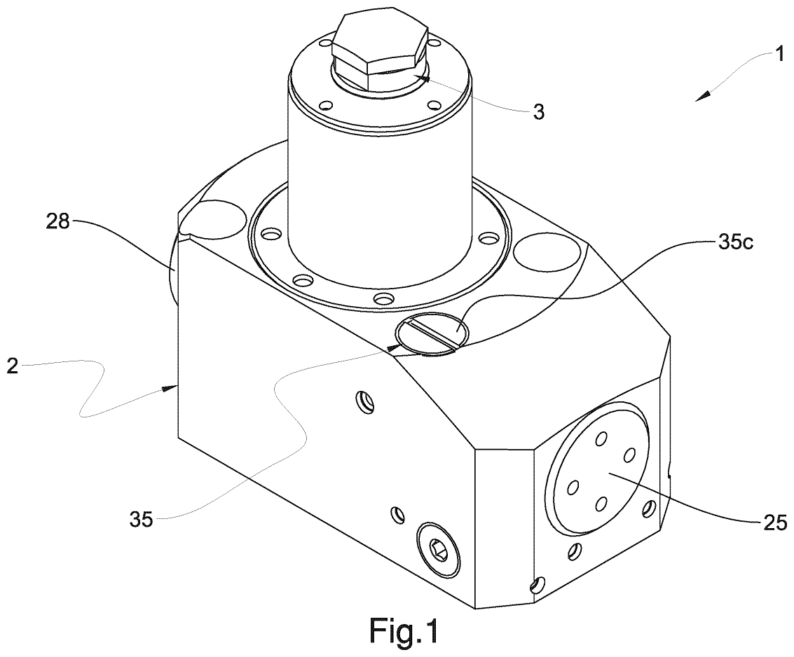

### EMBODIMENTS OF THE INVENTION

With particular reference to these figures, reference numeral 1 globally denotes a device for clamping workpieces on machine tools.

The device 1 for clamping workpieces on machine tools comprises, first of all:
at least one base body 2 fixable to a machine tool;
at least one clamping pin 3 of at least one workpiece to be machined associated with the base body 2 in a movable manner along a direction of work L between an extended position, wherein it allows clamping the workpiece, and a retracted position, wherein it allows releasing the workpiece; and, conveniently,
movement means 4 adapted to move the clamping pin 3 along the direction of work L and comprising at least one movement piston 5 associated with the clamping pin 3 and movable, as a result of the thrust of a pressurized fluid, along at least a first line V1 of the direction of work L oriented from the retracted position to the extended position.

In this regard, it is important to specify that, in the context of this disclosure, the expression “pressurized fluid” means any fluid in the liquid state (and therefore ideally incompressible) or in the gaseous state (and therefore compressible) used as a carrier medium for the transport of energy in a hydraulic or pneumatic circuit; preferably the pressurized fluid consists of a traditional mineral oil but alternative embodiments wherein it may be synthetic oil, vegetable oil, water, air or the like cannot be ruled out. This means, preferably, that the movement piston 5 is of the oil-hydraulic type and that it cannot however be ruled out that it may be, e.g., of the pneumatic type (in the case where the pressurized fluid be air) or hydraulic (in the case where the pressurized fluid be water).

In addition, it is also specified that, taking into account the presence in the device 1 of different parts in contact with the pressurized fluid, special gaskets are provided located at different points of the device 1 which, for simplicity of representation, have been commonly identified by the reference letter G.

As a further clarification, the possibility of manufacturing a device 1 lacking the movement means 4 cannot be ruled out.

Having specified this, the movement means 4 preferably comprise at least one respective first inlet chamber 6 of the pressurized fluid which is bounded by a first bottom wall 7 of the base body 2 and by the movement piston 5.

In this regard, the device 1 comprises at least one first circulation line C1 of the pressurized fluid which is connected to at least the first inlet chamber 6 and adapted to at least partly fill the latter with the pressurized fluid.

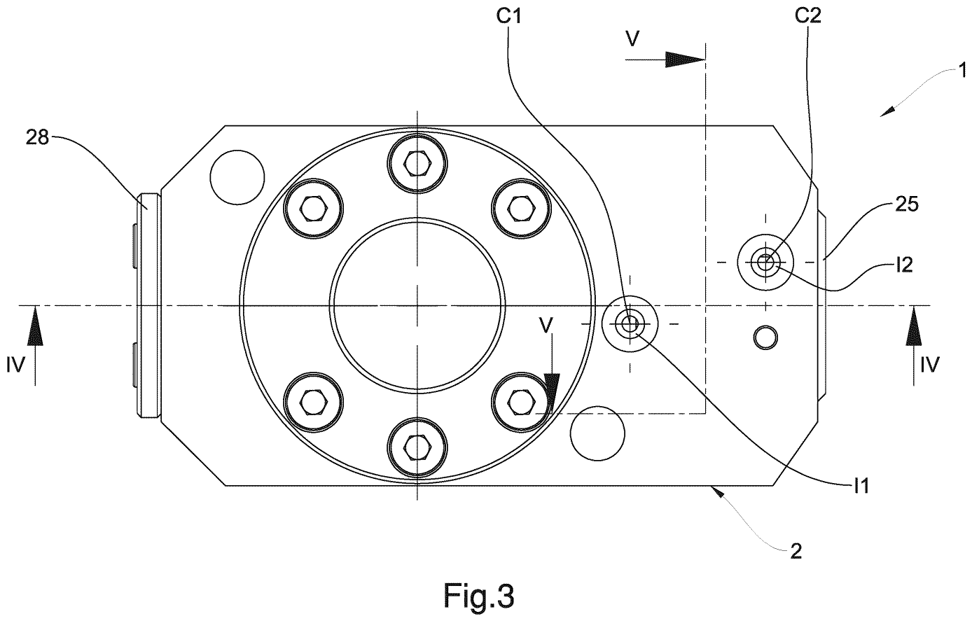

Specifically, the first circulation line C1 is connected to a relevant first supply inlet I1 (visible in FIG. 3) obtained on the side surface of the base body 2 and usable to at least partly fill the first circulation line C1 with the pressurized fluid.

Specifically, the first supply inlet I1 is connectable to a special pumping system of the pressurized fluid which allows the progressive filling of the first circulation line C1 and, consequently, of the first inlet chamber 6 with the pressurized fluid itself.

The aforementioned filling generates a thrust force on the movement piston 5 which causes the displacement thereof along the first line V1 of the direction of work L and allows, by virtue of this, the clamping pin 3 to slide from the retracted position to the extended position.

To enable the movement of the movement piston 5 and, therefore, of the clamping pin 3 in the opposite line, the movement means 4 advantageously comprise at least one elastically compressible element 8 positioned between the movement piston 5 and the base body 2.

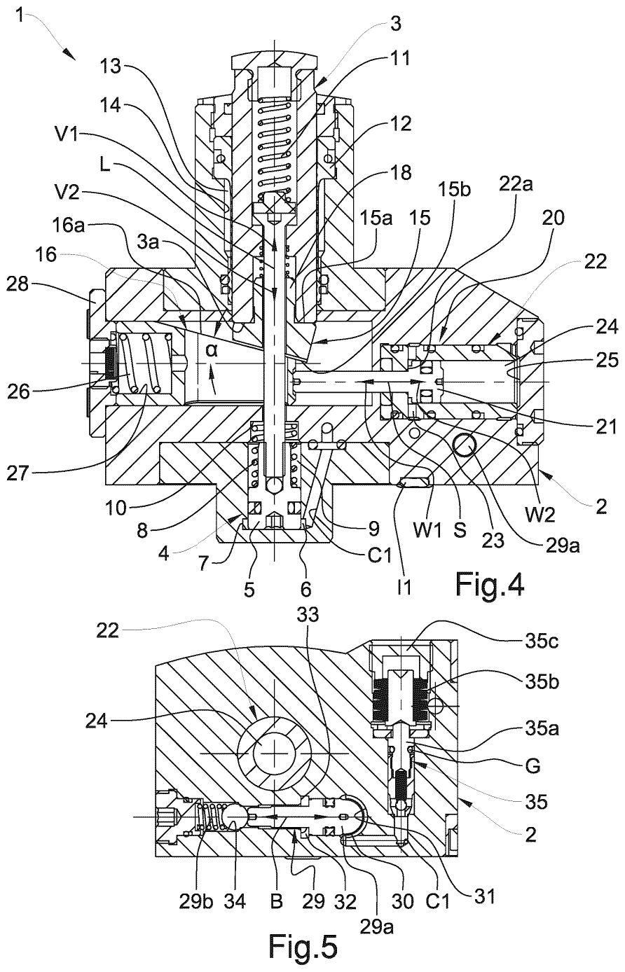

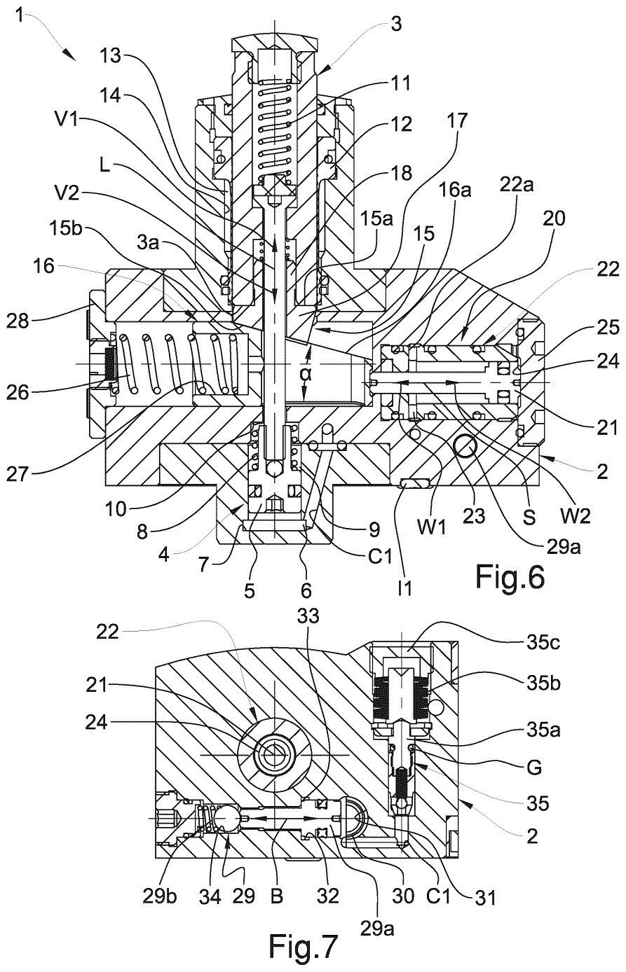

In this regard, the movement means 4 comprise a housing chamber 9 which is adapted to contain the elastically compressible element 8 and is bounded by a second bottom wall 10 of the base body 2 and by the movement piston 5 (FIGS. 4 and 6).

In the present case, the elastically compressible element 8 is adapted to move the clamping pin 3, as a result of the release of an elastic compressive force, along a second line V2 of the direction of work L opposite the first line V1.

This means that the elastically compressible element 8 is progressively compressed during the movement of the movement piston 5 along the first line V1 of the direction of work L, acquiring an amount of elastic energy proportional to its own rate of shortening.

The elastic energy thus accumulated can, therefore, be released on the movement piston 5 as a result of the discharge of the fluid contained in the first inlet chamber 6; in this way, the movement piston 5 is displaced along the second line V2 of the direction of work L and the clamping pin 3 can return to the retracted position.

In actual facts, it can be inferred from what has been described so far that the movement piston 5 is preferably of the single-acting type, that is, its displacement along the direction of work L is governed by the pressurized fluid for only one line thereof (i.e., the first line V1).

That said, alternative embodiments of the movement means 4 cannot be ruled out wherein the latter are without the elastically compressible element 8 and wherein the movement of the movement piston 5 is governed by the pressurized fluid in both lines V1, V2 of the direction of work L.

In other words, it cannot be ruled out that the housing chamber 9 can also be connected to a respective circulation line of the pressurized fluid, actually making the movement piston 5 of the double-acting type.

Again, the movement means 4 comprise at least one spring element 11 positioned between the clamping pin 3 and the movement piston 5.

Specifically, the spring element 11 is adapted to exert a resisting force, oriented along the second line V2 of the direction of work L, on the movement piston 5 as a result of achieving the extended position by the clamping pin 3.

In actual facts, the spring element 11 counteracts the further displacement of the movement piston 5 along the first line V1 of the direction of work L, allowing the stroke thereof to be stopped when a condition of equilibrium is achieved between the elastic force generated thereby and the thrust exerted by the pressurized fluid on the clamping pin 3.

As will be explained later in the disclosure, achieving this equilibrium condition plays an important role in adjusting the operation of some of the main components of the device 1 and, therefore, in controlling the overall operation of the device itself.

Then, the device 1 comprises at least one blocking bushing 12 fitted at least partly around the clamping pin 3 and deformable as a result of the thrust of a pressurized fluid between a clamping configuration of the clamping pin 3 and a release configuration of the clamping pin 3.

In this regard, as visible in FIGS. 4 and 6, the device 1 comprises a second inlet chamber 13 of the pressurized fluid which is bounded by a perimeter wall 14 of the base body 2 and by the blocking bushing 12.

Specifically, the second inlet chamber 13 is connected to the first circulation line C1 and, therefore, is filled by the pressurized fluid at substantially the same time as the first inlet chamber 6.

This results in the blocking bushing 12 being deformed in the clamping configuration where the clamping pin 3 switches to the extended position, thus allowing a frictional force to be exerted on the latter in order to counteract the movement thereof along the second line V2 of the direction of work L.

This fact also causes that, as a result of the discharge of the first inlet chamber 6 and of the second inlet chamber 13, the blocking bushing 12 is deformed in the release configuration, thus releasing the aforementioned frictional force on the clamping pin 3 and allowing the latter to return to the retracted position.

According to the invention, the device 1 comprises at least one supporting assembly 15, 16 adapted to physically support the clamping pin 3 in the extended position and comprising:
at least one supporting element 15 defining a respective first resting surface 15a; and
shifting means 16 on which the supporting element 15 is arranged in support which means are associated with the base body 2 and are adapted to move the supporting element 15 along the direction of work L and to arrange it, when the clamping pin 3 is in the extended position, in a supporting configuration wherein the first resting surface 15a is placed in contact with a respective second resting surface 3a of the clamping pin 3 (FIG. 6).

In actual facts, the shifting means 16 place the supporting element 15 in contact with the clamping pin 3 when the latter is in the extended position; therefore, in the supporting configuration, the supporting element 15 is physically positioned between the shifting means 16 and the clamping pin 3 and prevents, by virtue of this, any displacement of the latter from the extended position.

It is important to explain from the very beginning how this expedient proves decisive in remedying the drawbacks of the prior art previously complained of.

In this regard, the support provided by the supporting assembly 15, 16 to the clamping pin 3 enables the latter to hold itself firmly in the extended position regardless of the intensity of the forces exerted thereon by the workpiece, which benefits the machining quality achievable for the workpiece clamped thereby.

In other words, the presence of the supporting assembly 15, 16 makes it possible to compensate for any stresses exerted by the workpiece on the clamping pin 3 and, therefore, on the blocking bushing 12, thus preventing these loads from causing even the slightest displacement of the clamping pin 3 from the extended position.

Not only that, but thanks to this expedient, the device 1 can operate, its size being equal, at lower working pressures than known devices, thus being highly more efficient than the latter in its use.

Similarly, this fact also implies that it is possible to reduce the size of the device 1 while retaining the same performance offered by known devices; it is easy to appreciate that under-sizing the device 1 allows not only to reduce the expense of producing the device itself, but also to make it somewhat easier to manage and use.

Ultimately, the presence of the supporting assembly 15, 16 makes it possible to obtain a device 1 distinguished by timely operation, remarkable versatility of use, and greater convenience and reliability of use.

As for the supporting element 15, it comprises at least one base portion 17 provided with the first resting surface 15a and arranged in contact with the shifting means 16 (FIGS. 4 and 6).

Again, preferably, the supporting element 15 comprises at least one centering portion 18 associated with the base portion 17 and inserted at least partly into the clamping pin 3. The centering portion 18 is conformed elongated along the direction of work L.

More precisely, the centering portion 18 has a substantially cylindrical conformation. In the present case, the longitudinal axes of the centering portion 18 and of the clamping pin 3 are overlapped with each other and with the direction of work L.

Thanks to its partial insertion into the clamping pin 3, the presence of the centering portion 18 makes the operation of the supporting assembly 15, 16 particularly precise and repeatable, allowing, in particular, the shifting means 16 to arrange the supporting element 15 in the supporting configuration accurately and effectively whenever the clamping pin 3 is moved to the extended position.

That said, the possibility of making a supporting element 15 without the centering portion 18 and, therefore, provided only with the base portion 17 cannot however be ruled out.

Going into the details of the shifting means 16, they comprise at least one wedge-shaped body 16 which is movable along a direction of sliding S between an operating position (FIG. 6), wherein it places the supporting element 15 in the supporting configuration, and a home position (FIG. 4), wherein it moves the supporting element 15 away from the supporting configuration.

Specifically, the movement of the wedge-shaped body 16 along the direction of sliding S causes the movement of the supporting element 15 along the direction of work L.

In this regard, the direction of sliding S is transverse to the direction of work L.

More specifically, the direction of sliding S is substantially orthogonal to the direction of work L.

Again, the wedge-shaped body 16 is provided with a respective first inclined surface 16a arranged in contact with a respective second inclined surface 15b of the supporting element 15 (FIG. 4 and FIG. 6).

Specifically, the second inclined surface 15b is made on the base portion 17 of the supporting element 15.

Specifically, the second inclined surface 15b and the first resting surface 15a are in opposite positions on the base portion 17.

As far as the inclined surfaces 15b, 16a are concerned, they are inclined by a characteristic angle α of less than 20° with respect to the direction of sliding S.

It should be explained that this characteristic angle α makes it possible to obtain a device 1 with the so-called “irreversible” operation, i.e., capable of holding the clamping pin 3 in the extended position also in the event of a sudden pressure drop within the device itself due, e.g., to a malfunction of the external pumping system.

This means, in actual facts, that thanks to this angle, the forces exerted by the workpiece on the clamping pin 3 do not, under any circumstances, cause the wedge-shaped body 16 to displace along the direction of sliding S, thus ensuring that the supporting element 15 is firmly held in the supporting configuration and, therefore, secure clamping of the workpiece on the machine tool.

In this regard, it is specified that the characteristic angle α is preferably comprised between 5° and 20°, better still of between 10° and 20°.

In this way, it is possible not only to achieve the advantages outlined so far about irreversibility, but also to obtain a wedge-shaped body 16 having limited overall dimensions along the direction of sliding S and having, therefore, very compact dimensions.

More preferably, the characteristic angle α is substantially equal to 15°.

In fact, such a value proves to be quite suitable to minimize the overall dimensions of the wedge-shaped body 16 along the direction of sliding S and to obtain, at the same time, a device 1 with perfectly irreversible operation.

Having said all this, it cannot however be ruled out to provide for a characteristic angle α of a value different from those indicated and, e.g., greater than 20°.

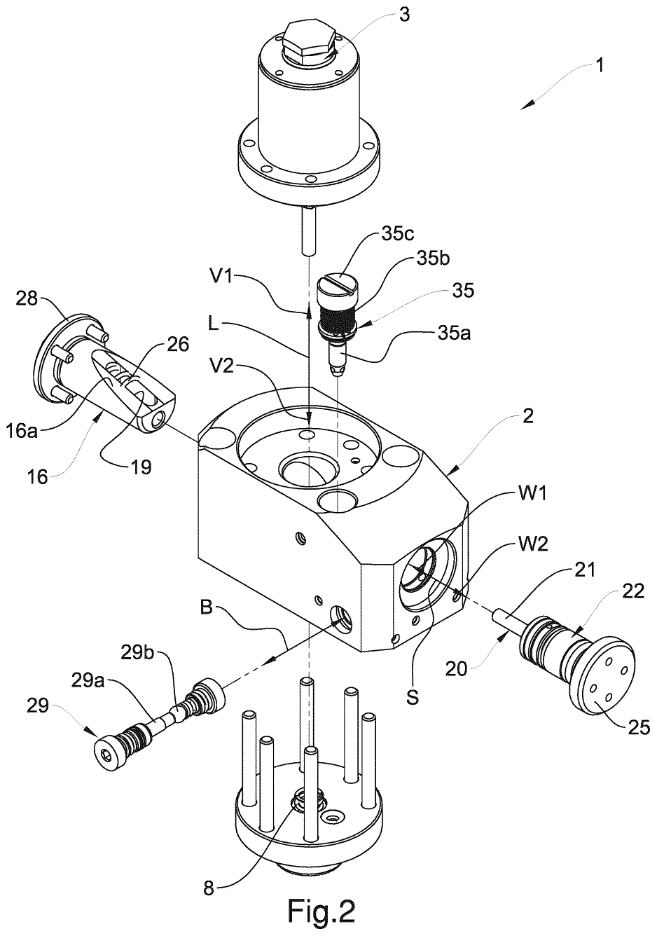

Detailing the wedge-shaped body 16 even deeper, it is specified that, as visible in FIG. 2, it comprises at least one slot 19 formed passing through on at least part of the first inclined surface 16a, the movement piston 5 being inserted into the slot 19.

Specifically, the slot 19 is entirely formed along the first inclined surface 16a.

Thus, the presence of the slot 19 allows the movement piston 5 to pass through the wedge-shaped body 16 and to connect, thus, to the clamping pin 3, enabling the movement thereof along the direction of work L.

Conveniently, the device 1 comprises sliding means 20 associated with the wedge-shaped body 16 and in turn comprising at least one sliding piston 21 which is movable, as a result of the thrust of a pressurized fluid, along the direction of sliding S and is adapted to allow the sliding of the wedge-shaped body 16 along at least one first way W1 of the direction of sliding S.

In this regard, the sliding means 20 comprise at least one sliding bushing 22 into which the sliding piston 21 is inserted along the direction of sliding S in a sliding manner.

Again, the sliding means 20 comprise at least one of:
a respective third inlet chamber 23 of the pressurized fluid which is bounded by an extremal wall 22a of the sliding bushing 22 and by the sliding piston 21; and
a respective fourth inlet chamber 24 of the pressurized fluid which is bounded by a closing bottom 25 attached to the base body 2 and by the sliding piston 21.

Preferably, the sliding means 20 comprise both the third inlet chamber 23 and the fourth inlet chamber 24.

In this sense, the movement of the sliding piston 21 along the direction of sliding S is entirely controlled by the pressurized fluid; for this reason, therefore, it can be stated that the sliding piston 21 is of the double-acting type.

Precisely, by sending the pressurized fluid into the third inlet chamber 23, it is possible to make the sliding piston 21 slide along the first way W1 of the direction of sliding S, while by sending the pressurized fluid into the fourth inlet chamber 24, it is possible to make the sliding piston 21 slide along a second way W2, opposite the first way W1 of the direction of sliding S.

That said, it cannot however be ruled out that the sliding piston 21 may be of the single-acting type.

In this case, the movement of the sliding piston 21 along the first way W1 of the direction of sliding S is dictated by the pressurized fluid, while the movement of the sliding piston 21 along the second way W2 can, e.g., be adjusted by one or more elastic members adapted to allow the reversal of motion.

Sticking to the preferred embodiment, wherein the sliding piston 21 is double-acting, it is specified that, conveniently, the third inlet chamber 23 is connected to the first circulation line C1, while the fourth inlet chamber 24 is connected to a second circulation line C2 of the pressurized fluid different from the previous one.

In this regard, the second circulation line C2 is in turn connected to at least a relevant second supply inlet I2 (FIG. 3) obtained on the side surface of the base body 2 and usable to at least partly fill the first circulation line C1 with the pressurized fluid.

As mentioned for the first supply inlet I1, the second supply inlet I2 is also connectable to the pumping system of the pressurized fluid so that the second circulation line C2 and, consequently, the fourth inlet chamber 24 can be progressively filled with the pressurized fluid.

By virtue of the connections described so far, it can be inferred that by sending the pressurized fluid along the first circulation line C1 it is possible to supply the first inlet chamber 6, the second inlet chamber 13 and the third inlet chamber 23, while by sending the pressurized fluid along the second circulation line C2 it is possible to supply the fourth inlet chamber 24.

In this sense, it is anticipated that, as will be clarified shortly, the displacement of the clamping pin 3 to the extended position is related to the movement of the sliding piston 21 along the first way W1 of the direction of sliding S, and that the return of the clamping pin 3 to the retracted position is related to the movement of the sliding piston 21 along the second way W2 of the direction of sliding S.

In order to ensure the proper movement of the shifting means 16, the sliding means 20 comprise at least one deformable body 26 adapted to move the wedge-shaped body 16, as a result of the release of an elastic compressive force, along the second way W2 of the direction of sliding S.

With particular reference to FIGS. 2, 4 and 6, the deformable body 26 substantially consists of one or more springs, preferably of the helical type.

Conveniently, the wedge-shaped body 16 is provided, within itself, with a respective containment cavity 27 wherein the deformable body 26 is at least partly inserted.

Specifically, one end of the deformable body 26 is arranged in contact with the bottom wall of the containment cavity 27, while the other end of the deformable body 26 is arranged in contact with a closing plate 28 attached to the base body 2.

This means that the end of the deformable body 26 arranged in contact with the bottom wall of the containment cavity 27 is movable along the direction of sliding S, while the other end, the one, that is, arranged in contact with the closing plate 28, is fixed with respect to the base body 2.

It cannot however be ruled out that the wedge-shaped body 16 may lack the containment cavity 27 and, therefore, that the deformable body 26 be placed between the wedge-shaped body itself and the closing plate 28.

In all cases, the displacement of the sliding piston 21 and, therefore, of the wedge-shaped body 16 along the first way W1 of the direction of sliding S results in the progressive compression of the deformable body 26 which, by releasing the elastic force thus accumulated on the wedge-shaped body 16, allows the latter to be displaced along the second way W2 of the direction of sliding S.

This means that the sliding piston 21 and the wedge-shaped body 16 move at the same time along the second way W2 of the direction of sliding S, the one as a result of the thrust exerted thereon by the pressurized fluid in the third inlet chamber 23, the other as a result of the release of the elastic force accumulated by the deformable body 26.

It is added that, conveniently, the inclined surfaces 15b, 16a develop close to the sliding piston 21 along the second way W2 of the direction of sliding S (FIG. 4 and FIG. 6). In other words, the tangent to the inclined surfaces 15b, 16a has negative slope running along the second way W2 of the direction of sliding S, this slope corresponding to the characteristic angle α.

Conveniently, the device 1 comprises at least one blocking valve 29, visible in FIGS. 2, 5, and 7, associated with the sliding means 20 in a fluid-operated manner and adapted to maintain the wedge-shaped body 16 in the home position.

Specifically, the blocking valve 29 comprises:
at least one plunger 29a movable along one direction of block B; and
at least one blocking body 29b operationally associated with the plunger 29a and compressible along the direction of block B between a compressed position (FIG. 7), wherein it may be passed through by the pressurized fluid in both ways of the direction of block B, and a stretched position (FIG. 5), wherein it may be passed through by the pressurized fluid in only one way of the direction of block B.

In this regard, it is important to add that the base body 2 comprises:
at least a first introduction chamber 30 of the pressurized fluid which is connected to the first circulation line C1 and is bounded by a first bottom surface 31 and by the plunger 29a; and
at least a second introduction chamber 32 of the pressurized fluid which is connected to the second circulation line C2 and is bounded by the plunger 29a and by a second bottom surface 33 (FIGS. 5 and 7).

In addition, the base body 2 comprises at least one containment chamber 34 of the blocking body 29b communicating with the fourth inlet chamber 24.

As anticipated, when the blocking body 29b is in the compressed position, the pressurized fluid can flow in either way of the direction of block B between the second introduction chamber 32 and the containment chamber 34.

In other words, when the blocking body 29b is in the compressed position the second introduction chamber 32, the containment chamber 34 and the fourth inlet chamber 24 communicate with each other in a fluid-operated manner.

Conversely, when the blocking body 29b is in the stretched position, the pressurized fluid can flow in only one way of the direction of block B, precisely from the second introduction chamber 32 to the containment chamber 34.

In other words, the blocking body 29b prevents the pressurized fluid from flowing from the containment chamber 34 to the second introduction chamber 32 when it is in the stretched position.

Thanks to the possibility of isolating these chambers in a fluid-operated manner, the blocking valve 29 is able to ensure that they remain pressurized even in the event of unexpected pressure drops, with the result that such anomalies do not result in potential displacement of the wedge-shaped body 16 from the home position.

In this sense, it is easy to appreciate that the blocking valve 29 operates in conjunction with the technical expedients outlined so far in achieving a device 1 particularly reliable in its operation.

Optionally, the device 1 comprises at least one sequence valve 35 connected to the blocking valve 29 and adapted to selectively allow and prevent the access of the pressurized fluid to the blocking valve 29 (FIGS. 2, 5, and 7).

Specifically, the sequence valve 35 is connected to the first circulation line C1, therefore sending the pressurized fluid into the first inlet chamber 6, into the second inlet chamber 13 and into the third inlet chamber 23 results in the pressurized fluid being simultaneously conveyed towards the sequence valve itself.

Again, the sequence valve 35 is arranged upstream of the first introduction chamber 30 with respect to the way of flow of the pressurized fluid along the first circulation line C1.

In this way, the sequence valve 35 allows selective adjustment of the access of the pressurized fluid into the first introduction chamber 30.

In this regard, the sequence valve 35 comprises a spool 35a movable between an opening position, wherein it allows the flow of the pressurized fluid towards the blocking valve 29, and a closure position, wherein it obstructs the flow of the pressurized fluid towards the blocking valve 29.

In addition, the sequence valve 35 comprises at least one elastically compressible preload element 35b associated with the spool 35a and adapted to exert a counteracting force on the spool 35a as it switches from the closure position to the opening position. Therefore, in order to bring the spool 35a to the opening position, the fluid must have sufficient pressure to overcome not only the resistance offered by the spool itself, but also the aforementioned counteracting force exerted by the preload element 35b.

Preferably, the preload element 35b is of the type of a spring or of a set of springs.

More preferably, the preload element 35b is of the type of a disc spring or a of set of disc springs.

Conveniently, the sequence valve 35 comprises at least one adjusting member 35c operationally associated with the preload element 35b and adapted to allow the adjustment of the counteracting force exerted by the latter on the spool 35a.

Specifically, the adjustment of the adjusting member 35c allows the compression of the preload element 35b to be varied and, in this way, the counteracting force exerted by it. In detail, the adjusting member 35c is at least partly screwed onto the base body 2.

In this sense, the adjusting member 35c is screwable to increase the compression of the preload element 35b and, therefore, the countering force exerted on the spool 35a, and it is unscrewable to reduce the compression of the preload element 35b and, therefore, the counteracting force exerted on the spool 35a.

The provision of a sequence valve 35 allows fine-tuning of the operation of the device 1 and, in particular, setting the pressure that the pressurized fluid must have in order to gain access to the first introduction chamber 30 and operate the plunger 29a, resulting in a significant increase in the versatility of use of the device 1.

The operation of this invention is as follows.

First of all, the supply inlets I1, I2 of the device 1 are connected to the pumping system which allows (e.g., by means of a special drawer valve or similar distributor), the pressurized fluid to be sent to one of either the first circulation line C1 or the second circulation line C2 and the simultaneous discharge of the pressurized fluid contained in the other of either the first circulation line C1 or the second circulation line C2.

Specifically, in order to clamp the workpiece on the machine tool, the pressurized fluid is sent along the first circulation line C1, while the second circulation line C2 is discharged.

In doing so, the first inlet chamber 6 is gradually filled, thus generating a thrust force on the movement piston 5 which causes it to be displaced along the first line V1 of the direction of work L.

The clamping pin 3 is, therefore, gradually moved from the retracted position to the extended position, thus coming into contact with the workpiece.

Meanwhile, the introduction of the pressurized fluid into the second inlet chamber 13 causes pressurization of the blocking bushing 12 and its consequent deformation in the clamping configuration, resulting in exerting on the clamping pin 3 a frictional force directed in the first line V1 of the direction of work L and therefore, such as to counteract the displacement thereof from the extended position.

At the same time, the pressurized fluid is conveyed towards the third inlet chamber 23, resulting in its progressive filling, and onto the sequence valve 35; at this stage, however, the pressurized fluid still has insufficient pressure to put the spool 35a in the opening position, and its access towards the first introduction chamber 30 is, therefore, obstructed.

Once the workpiece is contacted, the resulting increase in pressure causes the movement piston 5, continuing its displacement along the first line V1 of the direction of work L, to begin compressing the spring element 11, thus increasing the elastic energy stored by it.

The spring element 11 thus stops the stroke of the movement piston 5 once the equilibrium condition is achieved between the elastic force and the pressure force exerted by the pressurized fluid in the first inlet chamber 6.

Meanwhile, the increase in pressure undergone by the fluid is such that it places the spool 35a in the opening position and, therefore, causes the fluid itself to flow into the first introduction chamber 30.

The pressurized fluid therefore exerts a thrust force on the plunger 29a which causes the latter to be displaced along the direction of block B and the consequent compression of the blocking body 29b in the compressed position.

In this way, the fluid contained in the fourth inlet chamber 24, in the containment chamber 34 and in the second introduction chamber 32 is made to flow towards the second communication line C2 and is therefore discharged.

By doing so, the pressurized fluid conveyed into the third inlet chamber 23 can push the sliding piston 21 in the second way W2 of the direction of sliding S and the deformable body 26 can release its elastic energy, by moving the wedge-shaped body 16 along the second way W2 of the direction of sliding S and by bringing the supporting element 15 to the supporting configuration.

As a result of this, the clamping pin 3 is supported by the supporting assembly 15, 16 as long as it is in the extended position, thus enabling the advantages of stability, precision and effective operation outlined so far to be achieved.

After the workpiece has been completed, the latter can be released from the device 1 by returning the clamping pin 3 to the retracted position.

To do this, the direction of flow of the pressurized fluid is reversed from the previous case; in other words, the pressurized fluid is sent along the second circulation line C2 and the first circulation line C1 is connected to discharge.

Thus, the pressurized fluid enters the second introduction chamber 32 and displaces the plunger 29a in the opposite way of the direction of block B (i.e., away from the blocking body 29b), moving the blocking body 29b to a stretched position.

The pressurized fluid introduced into the second introduction chamber 32 can still flow through the blocking body 29b and channel into the fourth inlet chamber 24 until it is completely filled.

Thanks to the fact that the blocking body 29b is in the stretched position, the fourth inlet chamber 24 is, at this point, isolated from the second introduction chamber 32 in a fluid-operated manner; as explained, this achieves the previously described advantages regarding the operational safety ensured by the device 1 in the event of pumping system failures or breakdowns.

At the same time, the discharge of the first circulation line C1 results in the deformation of the blocking bushing 12 in the release configuration and thus allows the cancellation of the frictional force generated on the clamping pin 3.

Again, this fact also results in the gradual emptying of the first inlet chamber 6, leading to the release of the elastic energy accumulated by the elastically compressible element 8 on the movement 5.

The movement piston 5 is, thus, moved along the second line V2 of the direction of work L, returning the clamping pin 3 to the retracted configuration.

The discharge of the first circulation line C1 also determines the progressive emptying of the third inlet chamber 23, with the result of causing the sliding piston 21 to be displaced along the first way W1 of the direction of sliding S as a result of the thrust exerted thereon by the fluid in the fourth inlet chamber 24.

This action causes the wedge-shaped body 16 to switch from the operational position to the work position and, therefore, the simultaneous movement of the supporting element 15 along the second line V2 of the direction of work L.

The clamping pin 3 is, therefore, displaced together with the supporting element 15 along the second line V2 of the direction of work L, returning to the retracted position and resulting, by virtue of this, in the complete release of the workpiece from the machine tool.

It has in practice been ascertained that the described invention achieves the intended objects.

In particular, the fact is emphasized that the special expedient of providing a supporting assembly allows the pin to be physically supported in the extended position, counteracting any displacement of the latter from that position and, therefore, allowing the workpiece clamped by it to be machined very effectively and smoothly.

Again, this same expedient allows, its performance being equal, to reduce the size of the device compared to known devices, thus lowering the associated expenses and handling difficulties.

Similarly, the presence of the supporting assembly makes it possible to obtain a device distinguished, its size being equal, by greater performance than known devices and, therefore, more versatile than the latter in its use.

Finally, it should be noted that the particular characteristic angle of the wedge-shaped body makes it possible to obtain an irreversible clamping device and, therefore, capable of holding the workpiece firmly clamped on the machine tool even in the event of any unexpected pressure drop within the device itself.

1) Device for clamping workpieces on machine tools, comprising:
at least one base body fixable to a machine tool;
at least one clamping pin of at least one workpiece associated with said base body in a movable manner along a direction of work (L) between an extended position, wherein it allows clamping said workpiece, and a retracted position, wherein it allows releasing said workpiece;
at least one blocking bushing fitted at least partly around said clamping pin and deformable as a result of the thrust of a pressurized fluid between a clamping configuration of said clamping pin and a release configuration of said clamping pin;
further comprising at least one supporting assembly adapted to physically support said clamping pin in said extended position and comprising:
at least one supporting element defining a respective first resting surface; and
shifting means on which said supporting element is arranged in support which are associated with said base body and are adapted to move said supporting element along said direction of work (L) and to arrange it, when said clamping pin is in said extended position, in a supporting configuration wherein said first resting surface (15a) is placed in contact with a respective second resting surface of said clamping pin.

2) Device according to claim 1, further comprising movement means adapted to move said clamping pin along said direction of work (L) and comprising at least one movement piston associated with said clamping pin and movable, as a result of the thrust of a pressurized fluid, along at least one first line (V1) of said direction of work (L) oriented from said retracted position to said extended position.

3) Device according to claim 2, wherein said movement means comprise at least one elastically compressible element positioned between said movement piston and said base body and adapted to move said clamping pin, as a result of the release of an elastic compressive force, along one second line (V2) of said direction of work (L) opposite said first line (V1).

4) Device according to claim 1, wherein said shifting means comprise at least one wedge-shaped body which is provided with a respective first inclined surface arranged in contact with a respective second inclined surface of said supporting element and is movable along a direction of sliding (S) transverse to said direction of work (L) between an operating position, wherein it places said supporting element in said supporting configuration, and a home position, wherein it moves said supporting element away from said supporting configuration, the movement of said wedge-shaped body along said direction of sliding (S) causing the movement of said supporting element along said direction of work (L).

5) Device according to claim 4, further comprising sliding means associated with said wedge-shaped body and in turn comprising at least one sliding piston which is movable, as a result of the thrust of a pressurized fluid, along said direction of sliding (S) and is adapted to allow the sliding of said wedge-shaped body along at least one first way (W1) of said direction of sliding (S).

6) Device according to claim 5, wherein said sliding means comprise at least one deformable body adapted to move said wedge-shaped body, as a result of the release of an elastic compressive force, along a second way (W2) of said direction of sliding (S) opposite said first way (W1).

7) Device according to claim 1, wherein said inclined surfaces develop close to said sliding piston along said second way (W2) of said direction of sliding (S).

8) Device according to claim 7, wherein said inclined surfaces are inclined by a characteristic angle (α) of less than 20°, with respect to said direction of sliding (S).

9) Device according to claim 1, further comprising at least one blocking valve associated with said sliding means in a fluid-operated manner and adapted to maintain said wedge-shaped body in said home position.

10) Device according to claim 1, further comprising at least one sequence valve connected to said blocking valve and adapted to selectively allow and prevent the access of said pressurized fluid to said blocking valve.
